(19) United States
(12) Patent Application Publication
(10) Pub. No.: US 2009/0236295 A1
(43) Pub. Date: Sep. 24, 2009

(54) IMMERSION FILTER UNIT FOR WASTEWATER TREATMENT AND PRODUCTION OF DRINKING WATER

(75) Inventors: Gerhard Braun, Saarbrücken (DE); Eric Belieres, Saarbrücken (DE); Kay Gunther Gabriel, Saarbrücken (DE); Manfred Volz, Grossrosseln (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: ITN NANOVATION AG, Saarbrücken (DE)

(21) Appl. No.: 12/299,787

(22) PCT Filed: May 8, 2007
(86) PCT No.: PCT/EP2007/004050

§ 371 Date: Jan. 28, 2009

(30) Foreign Application Priority Data
May 8, 2006 (DE) 10 2006 022 502.3

(51) Int. Cl. C02F 1/44; B01D 29/94; B01D 29/76; B01D 29/05

(52) U.S. Cl. 210/767; 210/450; 210/261

(57) ABSTRACT

A filter unit includes at least one ceramic filter and at least one mounting that liquid-tightly secures the filter in the mounting in such a way that a filtrate outflow via an interior portion of the filter through the mounting is provided, the filter being secured in the mounting by adhesive bonding with an adhesive.

### RELATED APPLICATIONS

This is a §371 of International Application No. PCT/EP2007/004050, with an international filing date of May 8, 2007 (WO 2007/128565 A2, published Nov. 15, 2007), which is based on German Patent Application No. 10 2006 022 502.3, filed May 8, 2006.

### TECHNICAL FIELD

This disclosure relates to filter units for wastewater treatment and production of drinking water and to components suitable for the manufacture and use of such filter units.

### BACKGROUND

Conventional wastewater treatment plants, as a rule, contain a settling tank in which, in a first step, coarse constituents are removed from the wastewater, an activated sludge tank and a secondary clarifying tank. In the activated sludge tank, microorganisms are used to decompose fecal matter or other organic substances contained in the wastewater. In the secondary clarifying tank, these microorganisms are usually separated from the wastewater again by sedimentation after the activated sludge tank and, if appropriate, recirculated at least partially into the activated sludge tank. However, in this case, a complete separation of the microorganisms, particularly by means of a sedimentation process, is not possible. Therefore, there is the risk that the microorganisms, sometimes harmful to health, may enter the environment together with the wastewater. This, as a rule, is unacceptable. There are therefore, for example, European Union directives for water pollution control, which, throughout Europe, stipulate that only clarified wastewaters which are essentially free of microorganisms should be discharged into the environment.

For reasons mentioned, therefore, the purified wastewater coming from the activated sludge tank is further treated by filtration by means of what are known as fine filters. In such cases, the microorganisms present can be reliably separated. Fine filters are to be understood in this context as meaning those filters which possess a sufficiently small pore size to retain the microorganisms during the filtration process. Such filters are often also designated as microfilters, ultrafilters, nanofilters or the like as a function of the pore size.

The problem that only biologically clarified wastewater which is essentially free of microorganisms should be discharged into the environment arises particularly with regard to those generating wastewaters who are not or cannot be connected to a public wastewater network. This applies in Europe, particularly in Germany above all, to rural areas. Thus, in Germany, particularly in East Germany, it is estimated that there are still several million people not connected to a public wastewater network. However, according to current statutory regulations, the corresponding households must be supplied either by means of such a connection to the wastewater network or by means of the operation of a small-scale wastewater treatment plant.

However, the above-mentioned problems also arise precisely in the case of small-scale wastewater treatment plants, and therefore, even here, as a rule, microorganisms which have been introduced from an activated sludge tank or from an activated sludge chamber have to be separated in a secondary clarification tank or in a secondary clarification chamber. Accordingly, particularly even for such situations, corresponding filter systems have to be made available. These should not overshoot specific dimensions precisely with regard to small-scale wastewater treatment plants and are to be distinguished by as simple a type of construction as possible. Furthermore, it is precisely here where there is the problem that existing plants which still operate, for example, with a sedimentation of the microorganisms during secondary clarification should and must be retrofitted with filter systems.

In plants for wastewater treatment, but also for the production of drinking water, which in any case use filters, it is, as a rule, state of the art to use organic filters or filter membranes. These are often arranged in what is known as modular form, that is to say at least two, but, as a rule, a multiplicity of membranes are fastened in a holding device, and then the liquid to be filtered flows through them. Reference may be made in this context, for example to EP-A1-602560, to WO-A-03/037489 and to WO-A-2004/091755.

Furthermore, filters made from ceramic material are also known which can be used for separating solid constituents from liquids.

Thus, DE-A-26 03 505 describes a flat membrane module for separating processes in the liquid phase. However, the filters described there are suitable to only a limited extent for practical use in the above-mentioned applications. Thus, these filters have no ducts which are arranged inside the filter and through which the filtrate could be drawn off. The result of this is that only one side of the filter can be acted upon by the liquid to be filtered, and the filtrate is drawn off in each case via the opposite side of the filter. Moreover, the filters of DE-A-26 03 505 have to be drilled through to be installed in the module, and this may present problems with regard to ceramic materials.

DE-C43 29 473 likewise describes pressure-stable inorganic filter membranes which, however, are highly complicated to manufacture. Thus, two plate-shaped halves with semicircular indentations, which then later form internally running filtrate ducts, are sintered together. Furthermore, DE-C-43 29 473 does not address the way in which the membranes described can be integrated into a filter system.

By contrast, DE-A-198 07 769 discloses a mounting for ceramic microfilters, into which mounting a ceramic flat filter (membrane plate) can be inserted. For this purpose, on the mounting, a clearance is provided, of which the contour, as seen in the top view, corresponds approximately to the cross section of the microfilter to be inserted therein. The necessary liquid tightness is achieved with the aid of rubber seals which are introduced between the walls of the clearance and the microfilter. The liquid to be filtered can thereby flow freely around a large part of the filter inserted into the mounting, and the filtrate is discharged through the mounting with the aid of a slight vacuum via the ducts provided inside the filter.

The collecting duct necessary for discharging the filtrate from various mountings is implemented, in DE-A-198 07 769, by a corresponding configuration of the mounting itself, in that extensions provided can communicate with one another. Thus, a plurality of mountings can then be placed one above the other and correspondingly form a collecting duct integrated into these mountings.

The configuration of the mounting and of the filter unit formed from it in DE-A-198 07 769 may be a disadvantage because rubber seals sometimes cannot provide the necessary liquid tightness. This is the case particularly when the filtrate is sucked away by means of a comparatively high pressure difference (vacuum). Unfiltered liquid may then penetrate into the mounting and consequently into the filtrate collecting duct which is actually to contain only filtered liquid freed of microorganisms. A lack of liquid tightness may also occur, in particular, during backwashing of the filter unit. In this case, the liquid stream is returned through the filter, specifically usually with a comparatively high liquid pressure, to free the filter surface and the filter interior of impurities (residue with microorganisms, etc.).

On the other hand, the filter system disclosed in DE-A-198 07 769 makes it difficult to exchange individual filter units/mountings. Since the collecting duct is formed by the mountings being plugged on one above the other, a single filter unit/mounting can be exchanged only when all the filter units/mountings arranged above or below are removed. A defective filter plate/membrane therefore cannot be exchanged in a simple way.

It could therefore be helpful to provide a filter system which possesses as simple a set-up as possible. Correspondingly, it could be helpful that both the individual components are set up in as simple a way as possible and their assembly is capable of being implemented as simply as possible. At the same time, during use, as simple an exchange of individual filters or of individual filter units as possible would also be helpful.

### SUMMARY

We provide a filter unit including at least one ceramic filter and at least one mounting that liquid-tightly secures the filter in the mounting in such a way that a filtrate outflow via an interior portion of the filter through the mounting is provided, the filter being secured in the mounting by adhesive bonding with an adhesive.

We also provide a mounting for liquid-tightly securing ceramic filters including a receptacle, the form of which corresponds essentially to a cross section of a filter to be secured in it, a filtrate outlet that connects to a filtrate collecting duct or filtrate collecting pipe provided on the mounting.

We further provide a collecting duct or collecting pipe for filtrates obtained with the aid of ceramic filters, wherein the collecting duct is formed in one piece, and at least one receptacle that connects to filtrate outlets of a mounting for ceramic filters and at least one filtrate collecting outlet that diverts the filtrate out of the collecting duct.

We still further provide a holding device for filter units with at least one ceramic filter and at least one mounting that liquid-tightly secures the filter in the mounting, wherein the holding device has at least one frame and means for securing at least one filtrate collecting duct.

We further yet provide a method of treating wastewater and/or producing drinking water, including feeding wastewater or water to the filter unit.

### BRIEF DESCRIPTION OF THE CLAIMS

Those and further advantages arise from the examples described below in connection with the figures. The individual features may in each case be implemented by themselves or in combination with one another. The examples described below serve merely for an explanation and a better understanding and are in no way to be understood as being restrictive.

In the drawings:

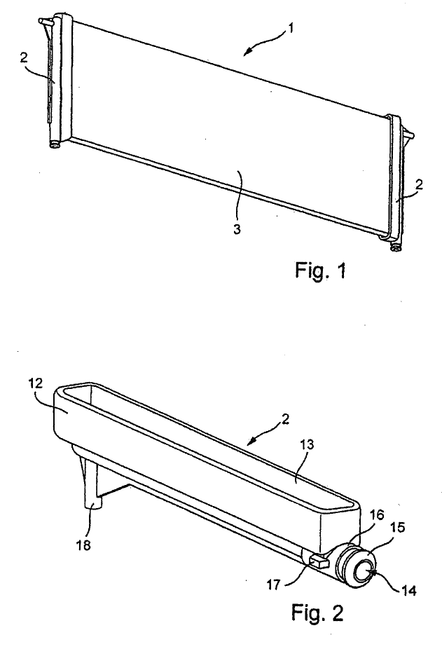

FIG. 1 shows a filter unit consisting of a ceramic flat filter and of two mountings;

FIG. 2 shows a mounting as shown in FIG. 1, for the liquid-tight securing of ceramic flat filters;

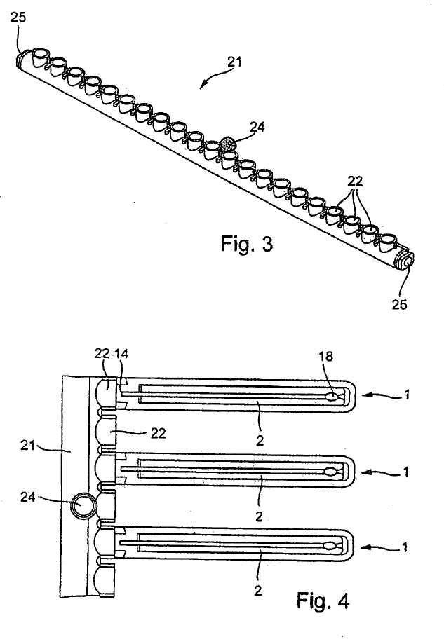

FIG. 3 shows a collecting duct for the reception of filter units as shown in FIG. 1, or of mountings as shown in FIG. 2;

FIG. 4 shows a plan view from below of a collecting duct as shown in FIG. 3, which is equipped with filter units as shown in FIG. 1, or with mountings as shown in FIG. 2 (part view);

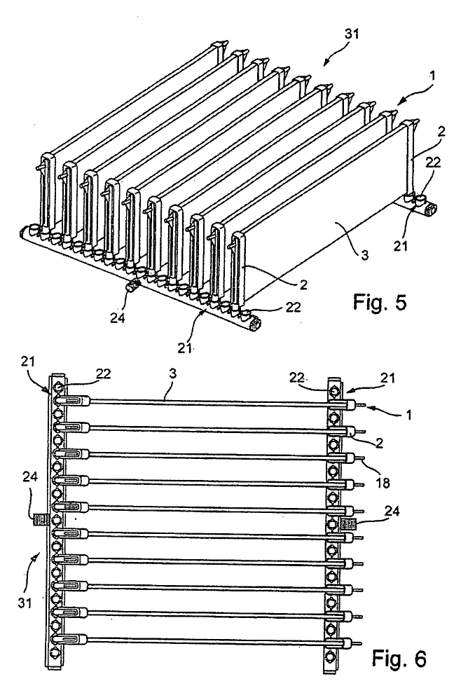

FIG. 5 shows a filter system consisting of two collecting ducts as shown in FIG. 3, which are equipped with filter units according to FIG. 1;

FIG. 6 shows a plan view of the filter system according to FIG. 5;

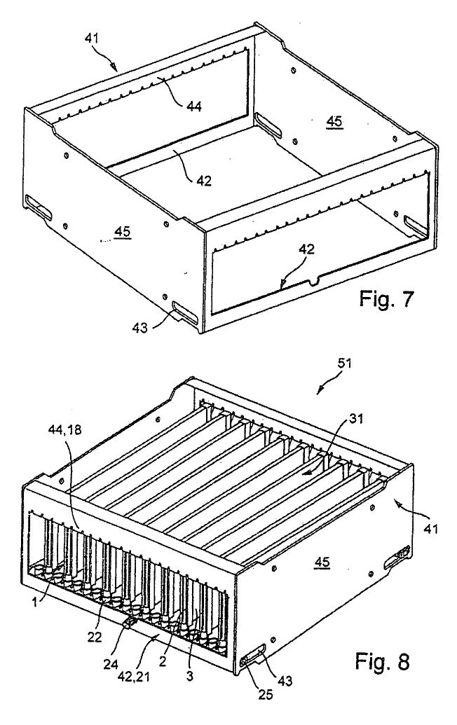

FIG. 7 shows a holding device for filter units, in particular for filter units according to FIG. 1; and

FIG. 8 shows the holding device according to FIG. 7, which is equipped with a filter system according to FIG. 5.

### DETAILED DESCRIPTION

We provide filter units having at least one ceramic filter, preferably a ceramic flat filter, and at least one mounting for the liquid-tight securing of the filter in the mounting. In this case, an outflow of the filtrate, that is to say of the purified (filtered) liquid phase, via the interior of the filter through the mounting is provided. The filter is secured (liquid-tight) in the mounting with the aid of an adhesive by adhesive bonding.

Simple and reliable sealing against liquid between the filter and the mounting can be provided by adhesive bonding. Thus, on the one hand, no additional components, such as sealing rings and the like, have to be provided, which may possibly also necessitate a complicated design of a mounting, for example, due to the provision of peripheral grooves into which the sealing ring has to be inserted. On the other hand, depending on the mounting or filter used, the adhesive provided for adhesive bonding can be applied in a directed manner to those regions of the mounting or of the filter which are particularly suitable for the liquid-tight connection.

As just mentioned, depending on the type and form of the filter or on the form of the mounting, the adhesive bonding can be applied to completely different regions of the filter or of the mounting. Thus, for example, even non-angular filters, for example, round filters, can be glued into corresponding mountings. In all cases, however, it is preferable if the adhesive bonding is provided in at least one marginal region of the filter, in particular only in this marginal region of the filter. This is also explained in more detail below. An adhesive bond in the marginal region has the advantage that the remaining regions of the filter are available for the filtration itself. This region utilized for filtration is, of course, to be as large as possible to achieve a high filter action and a high liquid throughput.

In preferred constructions of the filter unit, the filter is an essentially rectangular flat filter. This is to mean that the topside and the underside of the filter are essentially rectangular. This is the preferred form of the ceramic flat filters or ceramic flat membranes which can be used.

To secure these last-described flat filters in the mounting, a receptacle is preferably provided, the form of which corresponds to the corresponding cross section of the filter secured in it. This is to be understood as meaning that flat filters of this type are introduced with one of their end faces into the receptacle of the filter and are secured in the receptacle by adhesive bonding at the marginal region which is thereby located within the receptacle. Correspondingly, here, the adhesive bond is provided between this marginal region of the filter and the inside, facing it, of the receptacle in the mounting.

In a development, the last-described versions may advantageously be implemented such that a preferably essentially rectangular flat filter is secured in two mountings by adhesive bonding on at least one side, preferably on two of its opposite sides, preferably on the two opposite end faces. Accordingly, such a flat filter is secured by adhesive bonding in each case in the marginal region within a receptacle of a mounting in each case. Thus, the filtrate entering the filter via the remaining exposed outer faces of the filter can flow out through two mountings lying opposite one another.

Basically, the most diverse possible adhesives are suitable for providing the necessary adhesive bond. Such adhesives can be selected appropriately by one skilled in the art. The necessary requirements to be met by the adhesive are, on the one hand, that it is capable of providing the necessary liquid tightness. In this regard, it must also possess the necessary longterm stability and should loose its advantageous properties at the earliest when the filter itself is ready to exchange. On the other hand, after curing, the adhesive should still possess some flexibility and elasticity and not become too brittle. This is particularly so that the forces acting on the filter during filtration operation are to some extent absorbed to avoid a breaking open of the adhesive bond or the formation of cracks in the ceramic material in the filter.

Finally, the adhesive must be suitable for promoting adhesion between the material of the filter and the mounting. Thus, the filter is made from a ceramic material and the mounting is made, as a rule, from plastic. This brings about necessary adhesion promotion between an inorganic material (ceramic) and an organic material (plastic).

In accordance with the statements last made, it is correspondingly preferable if the adhesive is what is known as a chemically hardening adhesive. With these adhesives, also designated as reaction adhesives, setting and, consequently, the occurrence of the adhesive action take place by the chemical reaction of corresponding constituents of these adhesives. Such chemically hardening adhesives are known. They may be used as 1-component adhesives (1C-adhesive), in which a ready-to-use adhesive mass is employed, and as 2-component adhesives (2C-adhesive), in which the adhesive is mixed together from two separate constituents before application. It is preferable if the adhesive is a 2-component adhesive.

The epoxy resin adhesives and polyurethane adhesives are to be emphasized particularly as adhesives which can be used. Both types of adhesive are sufficiently known. Epoxy resin adhesives generally have a 2-component composition. Polymer modules are used which carry at the end what are known as epoxy groups and which are mixed with a second component, the hardener, which contains amino or mercapto groups.

Polyurethane adhesives (PUR) are obtainable in the 1-component or 2-component type. They can harden by polycondensation or polyaddition. The basic chemistry is known.

The adhesive is preferably employed such that a closed strip-shaped or band-shaped adhesive bond is obtained. In the version already described, with a flat filter and with a corresponding receptacle in the mounting, such an adhesive bond correspondingly runs in the marginal region of the filter around this completely and thus leads to the necessary liquid tightness between the filter introduced into the receptacle and the inner walls of this receptacle.

The closed strip/band preferably possesses a width of between approximately 5 mm and approximately 25 mm, preferably of approximately 10 mm, and a thickness of between approximately 1 mm and approximately 5 mm, preferably of approximately 2 mm. By means of such dimensions, on the one hand, the necessary leaktightness can be achieved and, on the other hand, there is no need for too much adhesive to be used.

The adhesive may be applied both manually and in an alternated manner. Particularly preferably, the adhesive is applied by an adhesive robot.

In further preferred versions, the filter unit is configured such that the mounting has at least one filtrate outlet. This filtrate outlet is in this case provided preferably for connecting the mounting to at least one filtrate collecting duct or filtrate collecting pipe. The result is that a filtrate collecting duct separate from the filter unit can be provided, thus making the exchangeability of filter units in a filter system easier. This aspect is also explained in more detail later.

As mentioned initially, in the filter unit, an outflow of the filtrate via the interior of the filter through the mounting is provided. Accordingly, it is advantageous if the filter has inside it at least one filtrate duct which issues on at least one of the end faces of the filter. The filtrate collecting inside the filter in its pores can thereby be diverted into this duct and be conducted out of the filter via the end faces of the filter.

In a development, in such versions, in particular, there is provision for there to be a plurality of filtrate ducts, preferably these filtrate ducts running essentially parallel inside the filter and issuing correspondingly on the end face of the filter in orifices spaced apart from one another.

As already stated, the filters of the filter unit are ceramic filters, that is to say filters which are made from a porous ceramic material. Such filters can be manufactured in the desired dimensions, in particular as what are known as flat filters, extrusion through a mouthpiece in monolithic form, that is to say in one piece. In this case, the filtrate ducts mentioned are also formed at the same time inside the filter.

It is preferable if the filter is made at least partially from nano-scale particles or has at least one coating which consists of nano-scale particles. Usually, it would not be necessary and, for reasons of cost, also not expedient to make the entire filter, particularly the flat filter, or the membrane plate/filter plate from nano-scale material. For a good filtering action, it is sufficient if at least one separating layer, preferably an external separating layer, is made from the nanoscale particles.

Nano-scale particles are to be understood in this context to mean particles with a mean grain size of below 1 μm, preferably below about 500 nm, in particular below about 100 nm.

Such a coating provided on the flat filter preferably has a thickness of between about 100 nm and about 150 μm, preferably of between about 500 nm and about 100 μm. Thicknesses of the coating of approximately about 25 μm are further preferred within the last-mentioned range.

The pore size of such a coating consisting of ceramic nano-scale particles can be selected as a function of the microorganisms to be separated. Here, pores with a diameter of between 1 nm and about 1,500 nm, preferably of between about 50 nm and about 300 nm, may be provided. Diameters of the pores of between about 200 nm and about 300 nm are to be emphasized within the last-mentioned ranged.

The ceramic material which lies beneath the coating consisting of nano-scale particles and which may be designed as a substrate will, as a rule, have pores with a larger diameter than in the coating. This makes it easier to discharge the filtrate inside the filter. Accordingly, preferably pores with a diameter of between about 100 nm and about, 10 μm, preferably of between about 500 nm and about 3 μm, are provided in the ceramic material which forms the substrate.

Both oxidic ceramics and non-oxidic ceramics may be used as ceramic materials for the filter. Oxidic ceramics, in particular aluminum oxide ceramics and zirconium oxide ceramics, can be employed for preference.

The nano-scale particles of the coating are preferably also such aluminum oxide particles. In addition, in particular, nano-scale particles consisting of zirconium dioxide or titanium dioxide or else mixtures of all the oxidic particles mentioned are also suitable. Zeolites, too, can be employed for particularly small pore sizes.

The ceramic filters described are distinguished, as compared with filter membranes consisting of organic polymer material, by high mechanical and chemical resistance, a long service life and high pressure resistance. Moreover, they are easier to clean.

Furthermore, the ceramic filters, in particular the filters coated on their outer faces with a nano-scale ceramic material, can advantageously be operated by what is known as the dead-end method. In this, the liquid to be purified is pressed through the filter in the same way as in a blind alley. The work takes place correspondingly by virtue of a constant permeate flow through the filter, that is to say the same quantity of unfiltered liquid enters the filter and re-emerges as filtrate from the filter. The filtered-off impurities, for example the microorganisms, collect on the surface of the filter or in the corresponding narrow pores of the filter and are discharged or removed from the filter again at regular time intervals by backwashing, with a corresponding excess pressure being applied. The advantage of the dead-end method is that, in spite of the brief washing interruptions, a lower energy consumption is to be noted than in what is known as the cross-flow method, in which a large liquid volume has to be led permanently past the filter in circuit. Accordingly, in the cross-flow method, only ever part of the liquid is pressed through the filter.

Moreover, in the dead-end method, a more compact type of construction of the filter system, overall, can be implemented.

In addition to the filter unit described hitherto, we also provide a mounting for the liquid-tight securing of ceramic filters, particularly ceramic flat filters. Such a mounting is also designated as a “shoe,” since it is designed correspondingly for receiving a filter (in the same way as a shoe for receiving a foot).

The mounting possesses a receptacle, the form of which corresponds essentially to the cross section of a filter to be secured in it, and also a filtrate outlet which is designed to be connected to a filtrate collecting duct or filtrate collecting pipe. Accordingly, the mounting therefore does not form part of such a filtrate collecting duct, but, instead, is intended to be connected to a (separate) filtrate collecting duct.

The mounting is preferably an elongate, preferably one-piece body with an essentially rectangular or square cross section. In such configurations, the mounting receives a preferred configuration of the receptacle for the filter which is of course likewise intended preferably for the securing of essentially rectangular flat filters. Particular configurations of the mounting are also described in connection with the figures.

In a development, the filtrate outlet on the mounting is preferably designed as the plug connector which can cooperate with an associated receptacle in a filtrate collecting duct/filtrate collecting pipe. Thus, the filtrate outlet can be fastened, liquid-tight, to such a duct in a simple way and also removed from this duct again. This allows a rapid uncomplicated exchange of the mounting or of the filter unit having such a mounting on the collecting duct.

For this purpose, the plug connection may be configured as a latch or snap connection, corresponding latch or snap elements located respectively on the filtrate outlet and on the associated receptacle latching or snapping one to the other.

If appropriate, the leaktightness of the plug connection may be reinforced by additional sealing elements, for example, by a sealing ring which is provided at a filtrate outlet of circular cross section.

Further, positioning means may preferably be provided on the mounting and are intended for fixing the mounting in a holding device for filter units. Such a positioning means serve for fixing these mountings or filter units having these mountings in a holding device, in particular for a multiplicity of filter units, in the correct position and, if appropriate, fixing them there. This makes it easier to install such mountings or filter units in holding devices of this type.

In particular, the positioning means may be projections, in particular pin-shaped projections, which fit into corresponding orifices or recesses in the holding device. This is likewise also explained in more detail in connection with the figures.

The mounting is made preferably from a plastic, in particular from a plastic processable by injection molding. These are, in particular, thermoplastics which are. Polyethersulfone (PES) is preferred.

Further, we provide a collecting duct or a collecting pipe for the filtrates, in particular for filtrates which are obtained with the aid of ceramic filters, in particular ceramic flat filters. This collecting duct is formed in one piece and has at least one receptacle for connection to filtrate outlets of a mounting for ceramic filters, and also at least one filtrate collecting outlet for diverting the filtrate out of the collecting duct.

The design of the collecting duct is advantageous since the collecting duct is produced as a separate component of a filter system consisting of the filter unit and of the connecting duct. This means that such filter units can easily be connected to the collecting duct and also easily exchanged on the collecting duct. In preferred structures, there are about 2 to about 10 receptacles on the collecting duct, but they may also be a markedly larger number of receptacles which preferably cooperate with corresponding filtrate outlets of corresponding mountings or filter units.

The collecting duct has at least about 10, preferably at least about 20, receptacles for filtrate outlets. Thus, a multiplicity of mountings or filter units can be connected together on such a collecting duct to form, overall, a filter system. This is also explained in more detail in connection with the figures.

The collecting duct is made preferably from plastic, in particular from a plastic processable by injection molding. This plastic is particularly advantageously polyethersulfone (PES).

We further provide the collecting duct described, in the version where it is equipped with at least one filter unit described or with at least one filter mounting described. This version then corresponds, as a result, to a finished filter system which can be used in this form for wastewater treatment or for the production of drinking water.

Further, we provide a holding device for filter units with at least one ceramic filter, preferably ceramic flat filter, and with at least one mounting for the liquid-tight securing of the filter in the mounting. This holding device has at least one frame, preferably in the manner of a housing. This may also be described as the holding device being configured in the manner of a rack. This is a general term for holding devices which combine a number of smaller elements or components logistically into a larger unit.

Means for the securing of at least one filtrate collecting duct and, if appropriate, additionally, means for securing at least one filter unit are provided on this frame. Preferably, means for securing two filtrate collecting ducts are provided on the frame. The optionally possible securing of the filter units takes place preferably with the aid of orifices or recesses on the holding device into or onto which positioning means present on the filter units engage.

What is achieved by the design of the holding device is that individual filter units can be assembled into a larger filter system. This filter system can then be used, for example, as a module-like component in a plant for wastewater treatment or for the production of drinking water.

The filter units are secured in the holding device in that a filtrate collecting duct is fixed to the frame of the holding device via a suitable holding means. Since the filter units themselves are connected, in turn, to the filtrate collecting duct, these, too, are held in the holding device. In this case, for assistance, holding means for the filter units themselves may additionally be provided, and this may take place preferably via positioning means present on the filter unit.

In particular, the holding device is designed to secure two filtrate connecting ducts. Such versions are provided, in particular, for the cases where a filter, preferably a flat filter, is secured between two mountings for this filter so that a mounting is located in each case on two opposite side faces of the filter. The mountings arranged on both sides are then connected in each case to a filtrate connecting duct secured in the holding device. This is also explained in more detail in connection with the figures.

The holding device may basically be made from any material which is, in particular, resistant to the liquid to be filtered, that is to say, as a rule, corrosion-resistant. Suitable plastics are preferably used as a material for the holding device. In further preferred structures, the holding device is made from a corrosion-resistant metal or a corrosion-resistant metal alloy, in particular from high-grade steel.

Particularly preferred constructions of the holding device are obtained when these holding devices are equipped with at least one of the filter units and/or with at least one collecting duct. The holding device is then either a finished filter system or a filter system which is prepared for the installation of the filter units.

As already partly outlined, the provision of the claimed subjects (filter unit, mounting, collecting duct and holding device) affords a whole series of advantages.

Thus, we make it possible to use ceramic filters, in particular ceramic flat filters (ceramic flat membranes), in wastewater treatment or in the production of drinking water. Their advantageous properties, such as higher mechanical and chemical resistance, long service life, better cleaning behavior and the like, are put to full effect in this way.

These advantages can be implemented, in particular, since such filters can be assembled in a technically practical way into a filter system which contains a plurality of such filters.

Such arrangements make it possible to operate the filters in what is known as the deadend mode, the advantages of which have already been described further above.

The components are functional in themselves and can be combined with other components. However, selected advantages arise particularly in the versions in which the components which are coordinated with one another can be used in combination with one another.

Thus, the mountings can be assembled together with ceramic filters, particularly ceramic flat filters, into the filter units by adhesive bonding. These filter units can then be connected to the collecting duct, in particular plugged together with the latter. The components thus obtained, consisting of the collecting duct and of the filter units, can then be installed in the holding device so that a fully finished functional filter system is obtained.

This overall system can be extended, as desired, if appropriate by a modification of the components to allow its use in plants of a different order of magnitude (on the building block principle). The individual components of this filter system are connected to one another, liquid-tight, so that filtration by the vacuum method and backwashing at higher pressures can be carried out. Assembly can be implemented in a simple way, for example via the plug connections described between the filter outlet on the mounting of the filter unit and the corresponding receptacle on the collecting duct.

A particular advantage is afforded in that individual filter units can easily be exchanged. Since a separate collecting duct is provided, an individual filter unit can easily be removed, without other filter units arranged next to the filter unit to be exchanged having to be demounted.

A further advantage is the multiplicity of constructions for the filter system which are implementable. Thus, a variable number of filter units can be connected to the collecting duct in virtually any desired sequence and in a variable spacing. Thus, for example, only every second or every third receptacle on the collecting duct may be equipped with a filter unit to vary the spacing of the filters/filter plates. Optimal filter conditions can thereby be implemented in each case for various applications. Thus, for example, greater filter spacings may be selected if there is the fear of a blockage of the space between two filters by solid bodies in the liquid to be filtered (hair, sludge, etc.), what may be referred to as entanglement. Complicated cleaning operations can thereby be avoided.

In other instances, optimal space utilization with a large number of filters in a specific volume can be implemented by the filters being arranged as closely as possible (occupation of each receptacle on the collecting duct by filter units).

In addition, further components may be integrated into the filter system, for example a reception device for the membrane pipe aerator and aeration guide plates. The filter system particularly preferably has two or four aeration guide plates.

FIG. 1 shows a filter unit consisting of two mountings 2 in which a ceramic flat filter 3 is secured, liquid-tight, on two opposite end faces. This securing takes place in each case in that marginal region of the filter 3 which belongs to the side faces, specifically with the aid of an adhesive bond, not illustrated in any more detail in FIG. 1. For this purpose, the corresponding marginal regions of the filter 3 are pushed into the two mountings 2, so that the adhesive bond is correspondingly provided between the inner faces of the mounting 2 and the corresponding outer faces of the filter 3. This is also explained in more detail in connection with FIG. 2.

The filter 3 according to FIG. 1 is a rectangular ceramic flat filter consisting of aluminum oxide ceramic with a pore size of approximately 1 μm. This substrate material is manufactured in monolithic form by extrusion, specifically with the aid of a mouthpiece, so that filtrate ducts run parallel inside the filter 3 and issue onto those end faces which are introduced into the mountings 2. Thus, the filtrate entering the filter 3 can pass through the filter 3 on both sides into the two mountings 2. This is achieved, during operation, by a vacuum being applied. A ceramic coating consisting of nano-scale particles, in the present case aluminum oxide particles with a grain size of below 100 nm, is located on the ceramic substrate material (aluminum oxide ceramic). The thickness of this coating consisting of nano-scale ceramic material amounts to approximately 25 μm. The pore size formed in the coating amounts to between 200 nm and 300 nm.

FIG. 2 illustrates a mounting 2 according to FIG. 1 in more detail. The mounting 2 possesses an elongate one-piece (basic) body 12 which is made from polyethersulfone (PES) by the injection molding method. In this basic body 12, a receptacle 13 is formed, which serves for introducing and securing a ceramic filter (see FIG. 1). The form and dimensions of this recaptacle 13 are adapted to the form and dimensions of the corresponding ceramic filter (here, flat filter). In this case, the inner faces of the receptacle 13 serve for making adhesive connection with the corresponding regions of the flat filter with the aid of an adhesive, not illustrated in FIG. 2. For this purpose, the adhesive may be applied (manually or mechanically) either to the corresponding inner faces of the receptacle 13 and/or to the corresponding faces of the filter. To achieve a liquid-tight closure, the adhesive bond provided by the adhesive runs around on the entire contact face between the receptacle 13 and the associated filter.

Further, in FIG. 2, there is a filtrate outlet 14, through which the filtrate which flows into the mounting 2 through the filter via the filtrate ducts of the latter can flow out of the mounting 2. The filtrate outlet 14 is designed as a plug or latch connection which can cooperate with a corresponding part of a filtrate collecting duct (not illustrated in FIG. 2). By means of the undercut/edge 15 provided on the filtrate outlet 14, a substantial positive connection with the corresponding component of the filtrate collecting duct is in this case possible. If appropriate, a sealing ring may be inserted into the peripheral groove 16, likewise illustrated in FIG. 2, at the filtrate outlet 14 and further improve the leaktightness of the connection between the mounting 2 and filtrate collecting duct.

Finally, in the region of the filtrate outlet 14, two projections 17 which are offset at 180° to one another, and only one of which is illustrated in FIG. 2, are also present on the mounting 2. These projections 17 serve as a stop for the mounting 2 plugged in a filtrate collecting duct.

Finally, FIG. 2 also shows a positioning means 18 which is provided on that side of the mounting 2 which lies opposite the filtrate outlet 14. This positioning means 18 is in the form of a largely pin-shaped projection which is integrally formed onto the basic body 12 as early as during the injection molding method. The exact function of this positioning means is likewise also explained in connection with FIGS. 7 and 8.

FIG. 3 shows a filtrate collecting duct 21. This is likewise made from polyethersulfone (PES) by the injection molding method and possesses 21 receptacles 22 for mountings 2, as shown in FIG. 2, of filter units 1, as shown in FIG. 1. It will be appreciated that a filtrate collecting duct of this type may be designed with any other desired number of receptacles 22.

According to FIG. 3, the receptacles 22 are designed such that they are suitable for receiving the filtrate outlets 14 according to FIG. 2 which are configured as plug connectors. Correspondingly, 21 mountings 2 according to FIG. 2 can be plugged onto the filtrate collecting duct 21 according to FIG. 3. In such a case, the collecting duct 21 is equipped fully with receptacles 2. FIG. 3 shows the variability of the collecting duct which makes it possible to equip even only some of the receptacles 22 with mountings 2. Thus, the spacing of corresponding filter units and consequently the spacing of individual ceramic flat filters can be varied. This has already been explained.

FIG. 3 shows, further, a filtrate collecting outlet 24 which in the present case has a screw thread. This outlet 24 is arranged centrally in the collecting duct 21, although this is not necessary in an appropriate case. In preferred constructions, the outlet 24 may also be arranged from the side, and this may afford advantages in the connection of a hose. The filtrate collecting duct 21 has at its two ends stopper-like end elements 25 which, depending on the particular version, either close off, liquid-tight, the filtrate collecting duct 21 or allow it to be plugged together with further collecting ducts 21. In the latter case, in module-like extension of the overall filter system is possible.

A filtrate collecting duct 21 which is equipped with filter units 1 or mountings 2 is illustrated in FIG. 4. This illustration is a plan view of the middle part of the filtrate collecting duct, the filtrate collecting outlet 24 (see also FIG. 3) which projects from the collecting duct 21 being directed towards the observer.

It can be seen in FIG. 4, further, that mountings 2 are introduced, preferably plugged, with their respective filtrate outlet 14 into every second receptacle 22 of the filtrate collecting duct 21. To understand the arrangement of the mountings 2 in the collecting duct 21 even more clearly, reference may be made here expressly to the disclosure content of FIGS. 2 and 3. The positioning means 18 (see also FIG. 2) illustrated on the mountings 2 are correspondingly likewise directed toward the observer.

An already largely functional filter system 31 is shown in FIG. 5. It can be seen there how a multiplicity of filter units 1 (10 filter units in the case illustrated), in each case with 2 mountings 2 and a filter 3, are plugged into two filtrate collecting ducts 21. The filter units 1 are illustrated in more detail in FIG. 1 and the filtrate collecting ducts 21 in FIG. 3.

It can also be seen clearly in FIG. 5 that every second receptacle 22 in the filter collecting duct 21 is equipped with a mounting 2 of the respective filter unit 1. A desired spacing is thereby maintained between the individual filter units 1. The advantages associated with this have already been explained. It is, of course, possible to equip each receptacle 22 of a collecting duct 21 with filter units 1 or else to leave two or more receptacles 22 free between two filter units 1. This shows the flexibility of our components compared to the prior art.

Correspondingly, according to FIG. 5, the liquid to be filtered can flow around the filter 3, and work can be carried out by what is known as the dead-end method. The filtrate then flows through the pores in the ceramic over into the interior of the filters 3 and is diverted through the filter ducts provided there on both sides of the filter 3 via the mountings 2 into the two filtrate collecting ducts 21. The filtrate can be diverted from there via the filtrate collecting outlet 24 out of the filter system 31. It will be appreciated, in this regard, that, when only some of the receptacles 22 on the filtrate collecting duct 21 are equipped, the receptacles 22 which remain free are closed, either as early as during manufacture or by means of dummy stoppers or the like.

FIG. 6 is a further illustration of the filter system 31 according to FIG. 5, specifically in a plan view from above. Here, too, the two filtrate collecting ducts 21 with their receptacles 22 can be seen, 10 filter units 1 being plugged into every second receptacle 22. The positioning means 18, the function of which will also be explained briefly, on the mountings 2 can also be seen clearly in FIG. 6.

A holding device 41 for the filter system 31 according to FIGS. 5 and 6 or for the filter units 1 according to FIG. 1 is shown in FIG. 7.

The holding device 41 is a housing-like or frame-like component 45 which may also be designated as a rack and which, in the present case, is made from high-grade steel or assembled from high-grade steel parts.

The holding device 41 has means 42 for securing two filtrate collecting ducts, these means 42 being designed in the manner of an angle piece. At their ends are provided orifices 43 which may serve for the additional securing of the filtrate collecting ducts.

Furthermore, FIG. 7 shows further securing means 44 in the form of recesses, and each recess may be assigned to a positioning means 18 on the mounting 2 of a filter unit 1.

A fully functional filter system S1 is shown in FIG. 8. Here, the preassembled filter system 51 according to FIGS. 5 and 6 is introduced into the holding device 41 according to FIG. 7. It can be seen clearly, particularly to the left part of FIG. 8, how the filtrate collecting ducts 21 are secured to the holding device 41 with the aid of the securing means 42 (angle pieces). In this case, the orifices 43 illustrated in FIG. 7 receive the end elements 25 of the filtrate collecting duct 21, thus bringing about additional fixing. For a further stabilization, the positioning means 18 on the mountings 2 engage into the recesses 44 on the holding device 41.

This gives rise, overall, to a mechanically stable filter system 51 which can be installed or integrated as a whole, as a kind of filter module, into a plant for wastewater treatment or for the production of drinking water. By virtue of the compact type of construction, a retrofitting of already existing plants with such filter systems 51 is also readily possible.

1-31. (canceled)

32. A filter unit comprising at least one ceramic filter and at least one mounting that liquid-tightly secures the filter in the mounting in such a way that a filtrate outflow via an interior portion of the filter through the mounting is provided, the filter being secured in the mounting by adhesive bonding with an adhesive.

33. The filter unit as claimed in claim 32, wherein the ceramic filter is a ceramic flat filter.

34. The filter unit as claimed in claim 32, wherein the adhesive bond is provided at least in a marginal region of the filter.

35. The filter unit as claimed in claim 32, wherein the filter is an essentially rectangular flat filter, a receptacle that secures the filter in the mounting, the form of the receptacle corresponding to a corresponding cross section of the filter secured in it.

36. The filter unit as claimed in claim 35, wherein the filter is secured on two of its opposite sides in two mountings by adhesive bonding.

37. The filter unit as claimed in claim 32, wherein the adhesive is a chemically hardening adhesive.

38. The filter unit as claimed in claim 32, wherein the adhesive is an epoxy resin adhesive.

39. The filter unit as claimed in claim 32, wherein the adhesive is a polyurethane adhesive.

40. The filter unit as claimed in claim 32, wherein the adhesive bond is provided as a closed strip-shaped or band-shaped adhesive bond.

41. The filter unit as claimed in claim 32, wherein the mounting has at least one filtrate outlet.

42. The filter unit as claimed in claim 41, wherein the outlet connects the mounting to at least one filtrate collecting duct or filtrate collecting pipe.

43. The filter unit as claimed in claim 32, wherein the filter has at least one interior filtrate duct which issues on at least one of end faces of the filter.

44. The filter unit as claimed in claim 40, further comprising a plurality of filtrate ducts.

45. The filter unit as claimed in claim 32, wherein the filter is made at least partially from nano-scale particles.

46. The filter unit as claimed in claim 32, wherein the filter has at least one coating which consists at least partially of nano-scale particles.

47. A mounting for liquid-tightly securing ceramic filters comprising a receptacle, the form of which corresponds essentially to a cross section of a filter to be secured in it, a filtrate outlet that connects to a filtrate collecting duct or filtrate collecting pipe provided on the mounting.

48. The mounting as claimed in claim 47, comprising an elongate body with an essentially rectangular or square cross section.

49. The mounting as claimed in claim 47, wherein the filtrate outlet is a plug connector that connects to an associated receptacle in the filtrate collecting duct/filtrate collecting pipe.

50. The mounting as claimed in claim 47, further comprising positioning means for fixing the mounting in a holding device for filter units on the mounting.

51. The mounting as claimed in claim 47, made from plastic.

52. A collecting duct or collecting pipe for filtrates obtained with the aid of ceramic filters, wherein the collecting duct is formed in one piece, and at least one receptacle that connects to filtrate outlets of a mounting for ceramic filters and at least one filtrate collecting outlet that diverts the filtrate out of the collecting duct.

53. The collecting duct as claimed in claim 52, comprising at least 10 receptacles for the filtrate outlets of mountings for ceramic filters.

54. The collecting duct as claimed in claim 52, comprising at least 20 receptacles for the filtrate outlets of mountings for ceramic filters.

55. The collecting duct as claimed in claim 52, made from plastic.

56. The collecting duct as claimed in claim 52, equipped with at least one filter unit as claimed in claim 1.

57. A holding device for filter units with at least one ceramic filter and at least one mounting that liquid-tightly secures the filter in the mounting, wherein the holding device has at least one frame and means for securing at least one filtrate collecting duct.

58. The holding device as claimed in claim 57, further comprising means for securing at least one filter unit.

59. The holding device as claimed in claim 57, made essentially of metal.

60. The holding device as claimed in claim 57, equipped with at least one filter unit as claimed in claim 32.

61. A method of treating wastewater and/or producing drinking water, comprising feeding wastewater or water to a filter unit according to claim 32.

62. The method according to claim 61, wherein the filter unit is a constituent of an immersion module.

63. The method according to claim 61, wherein the filter unit is a retrofit kit.

64. The method according to claim 61, wherein the filter unit is a small-scale clarification plant operated by a WSB® method.

65. The method according to claim 61, wherein the filter unit is in mobile residential or workplace container plants.

66. A method for treating wastewater and/or producing drinking water, comprising passing wastewater or water to a mounting according to claim 47.

67. The method according to claim 66, wherein the mounting is a constituent of an immersion module.

68. The method according to claim 66, wherein the mounting is a retrofit kit.

69. The method according to claim 66, wherein the mounting is in a small-scale clarification plant operated by a WSB® method.

70. The method according to claim 66, wherein the mounting is in a mobile residential or workplace container plant.

71. A method for treating wastewater and/or producing drinking water, comprising passing wastewater or water to a collecting duct according to claim 52.

72. The method according to claim 71, wherein the collecting duct is a constituent of an immersion module.

73. The method according to claim 71, wherein the collecting duct is a retrofit kit.

74. The method according to claim 71, wherein the collecting duct is in a small-scale clarification plant operated by a WSB® method.

75. The method according to claim 71, wherein the collecting duct is in a mobile residential or workplace container plant.

76. A method for treating wastewater and/or producing drinking water, comprising passing wastewater or water to a holding device according to claim 57.

77. The method according to claim 76, wherein the holding device is a constituent of an immersion module.

78. The method according to claim 76, wherein the holding device is a retrofit kit.

79. The method according to claim 76, wherein the holding device is in a small-scale clarification plant operated by a WSB® method.

80. The method according to claim 76, wherein the holding device is in a mobile residential or workplace container plant.
